(19) United States
(12) Patent Application Publication
(10) Pub. No.: US 2016/0361991 A1
(43) Pub. Date: Dec. 15, 2016

(54) UNDERBODY AIR AND THERMAL MANAGEMENT SYSTEM FOR A MOTOR VEHICLE

(71) Applicant: FORD GLOBAL TECHNOLOGIES, LLC, Dearborn, MI (US)

(72) Inventors: Lucas Apandi Phan, Canton, MI (US); John David Salinas, Dearborn, MI (US); Remo Recchia, Novi, MI (US); Perry Hollie, Farmington Hills, MI (US)

(21) Appl. No.: 14/737,601

(22) Filed: Jun. 12, 2015

(51) Int. Cl. B60K 11/08; B60K 11/06

(52) U.S. Cl. CPC B60K 11/085; B60K 11/06

(57) ABSTRACT

An underbody air and thermal management system is provided for a motor vehicle. That system includes an aero shield having a louver system selectively displaceable between an open position and a closed position. The system also includes an air dam that is selectively displaceable between a home position and a deployed position. Still further, the system includes a control system to displace the louver system between the open position and the closed position and the air dam between the home position and the deployed position so as to provide the best possible balance between aerodynamic airflow, under vehicle ground clearance and under hood or engine bay cooling.

### TECHNICAL FIELD

This document relates generally to the motor vehicle field and, more particularly, to an underbody air and thermal management system designed to relieve under hood/body pressure build up, improve vehicle aerodynamics and optimize airflow under the hood/body.

### BACKGROUND

Unoptimized underbody and under hood airflow can lead to a reduction in cooling system and heat exchanger performance. As pressure builds up under the hood, airflow to the vehicle heat exchangers and front end is reduced. Insufficient airflow to heat exchangers potentially leads to low cooling system performance and may require an upgrade to cooling system components that increases vehicle weight, power/energy consumption and production cost.

Unoptimized under hood airflow may also lead to under hood component management problems. This is because as under hood pressure builds up, airflow under hood is reduced, increasing air and component temperatures. This affects vehicle component operational thermal specifications. This may necessitate upgrades to vehicle under hood/body components in order to meet higher operating temperature specifications, further increasing weight, cost and energy consumption.

It should also be appreciated that vehicle aerodynamics plays an important role in reducing vehicle energy consumption. Underbody/hood shields are necessary to reduce vehicle aerodynamic drag. A fully enclosed underbody/hood shield is preferred to smooth out under vehicle airflow. Unoptimized and fully enclosed shields may lead to increases of under hood air pressure that can potentially lead to vehicle cooling and heat management issues under certain operating conditions including extreme weather and/or extreme load conditions.

This document relates to a new and improved underbody air and thermal management system including an active air dam and louvers that are effective in maximizing fuel economy while also properly managing under hood air and component temperatures based upon vehicle operation and power demands. Thus, the underbody air and thermal management system disclosed in this document represents a significant advance in the art.

### SUMMARY

In accordance with the purposes and benefits described herein, an underbody air and thermal management system is provided for a motor vehicle. That underbody air and thermal management system comprises an aero shield including a louver system selectively displaceable between an open position and a closed position. Further, this underbody air and thermal management system includes an air dam that is selectively displaceable between a home position and a deployed position. In addition, the underbody air thermal management system includes a control system to displace the louver system between an open position and a closed position and the air dam between a home position and a deployed position in response to operating conditions, vehicle operating modes and power demands.

The air dam is positioned vehicle forward of the louver system so that when the air dam is in the deployed position, the air dam forms a low-pressure area on an underside of the louver system to enhance airflow from the engine bay area under the hood through the louver system when the louver system is in the open position. In this way, enhanced engine bay or under hood cooling is provided.

More specifically, the control system includes a louver system actuator, an air dam actuator and a controller configured to operate the louver system actuator and the air dam actuator and thereby selectively displace (a) the louver system between the open and closed positions and (b) the air dam between the home and deployed positions. In one possible embodiment, the control system includes at least one sensor connected to the controller. That sensor may be selected from a group of sensors consisting of an engine coolant temperature sensor, a transmission oil temperature sensor, an engine charge air temperature sensor and combinations thereof. In one possible embodiment, the control system also includes a vehicle operating mode selector.

Still further, the controller is configured to provide three modes of operation. In the first operation mode, the louver system is closed and the air dam is in the home position to minimize air drag and maximize fuel economy. In the second operation mode, the louver system is in the open position and the air dam is in the home position to increase airflow through the engine bay while maximizing ground clearance for off-road operation of the motor vehicle. In the third operation mode, the louver system is in the open position and the air dam is in the deployed position to maximize airflow through the engine bay during high engine load operation such as during trailer towing.

In accordance with an additional aspect, a motor vehicle is provided equipped with the underbody air management system described herein.

In accordance with still another aspect, a method is provided for management of airflow under hood through an engine bay of a motor vehicle. That method may be broadly described as comprising the step of equipping the motor vehicle with an underbody air and thermal management system including: (a) an aero shield having a louver system displaceable between an open position and a closed position, (b) an air dam displaceable between a home position and a deployed position, and (c) a control system to displace the louver system and the air dam.

The method may be further described as including the step of providing the control system with a louver system actuator, an air dam actuator and a controller configured to operate the louver system actuator and the air dam actuator and thereby selectively displace (a) the louver system between the open and closed positions and (b) the air dam between the home position and the deployed position.

The method may further include the step of sensing engine coolant temperature by means of an engine coolant temperature sensor and providing engine coolant temperature data to the controller. Still further in one possible embodiment, the method may include sensing transmission oil temperature by means of a transmission oil temperature sensor and providing transmission oil temperature data to the controller. In yet another possible embodiment, the method may include sensing engine charge air temperature by means of an engine charge air temperature sensor and providing engine charge air temperature data to the controller. In yet another embodiment, the method may include sensing under hood air temperature by means of an under hood air temperature sensor and providing under hood air temperature data to the controller.

Still further, the method may include configuring the controller to provide a first mode of operation wherein the louver system is closed and the air dam is in the home position to minimize air drag and maximize fuel economy. In another possible embodiment, the method includes configuring the controller to provide a second mode of operation wherein the louver system is in the open position and the air dam is in the home position to increase air flow under hood through the engine bay while maximizing ground clearance for off-road operation of the motor vehicle. In yet another possible embodiment, the method includes configuring the controller to provide a third mode of operation wherein the louver system is in the open position and the air dam is in the deployed position to maximize airflow under hood through the engine bay during high engine load operation.

In still another possible embodiment, the method includes configuring the controller to provide one mode of operation wherein the louver system is in the closed position and the air dam is in the home position to minimize air drag and maximize fuel economy and another mode of operation wherein the louver system is in the open position and the air dam is in the deployed position to maximize airflow under hood through the engine bay during high engine load operation.

In the following description, there are shown and described several preferred embodiments of the underbody air and thermal management system. As it should be realized, that system is capable of other, different embodiments and its several details are capable of modification in various, obvious aspects all without departing from that system as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the underbody air and thermal management system and together with the description serve to explain certain principles thereof. In the drawing figures:

FIG. 1 is a bottom perspective view of a motor vehicle incorporating the underbody air and thermal management system that is the subject matter of this document.

FIG. 2 is a schematic block diagram of the control system for the underbody air and thermal management system illustrated in FIG. 1.

FIG. 3a is a cross-sectional view illustrating the underbody air and thermal management system of FIG. 1 in a first mode of operation wherein the louver system is in the closed position and the air dam is in the home position to minimize air drag and maximize fuel economy.

FIG. 3b is a cross-sectional view illustrating the underbody air and thermal management system of FIG. 1 in a second mode of operation wherein the louver system is in the open position and the air dam is in the home position to increase airflow under hood through the engine bay while maximizing ground clearance for off-road operation of the motor vehicle.

FIG. 3c is a cross-sectional view illustrating the underbody air and thermal management system of FIG. 1 in a third mode of operation wherein the louver system is in the open position and the air dam is in the deployed position to maximize airflow under hood through the engine bay during high engine load operation.

FIG. 4a is a bottom perspective view illustrating the underbody air and thermal management system of FIG. 1 in a first mode of operation wherein the louver system is in the closed position and the air dam is in the home position to minimize air drag and maximize fuel economy.

FIG. 4b is a top perspective view illustrating the underbody air and thermal management system of FIG. 1 in a second mode of operation wherein the louver system is in the open position and the air dam is in the home position to increase airflow under hood through the engine bay while maximizing ground clearance for off-road operation of the motor vehicle.

FIG. 4c is a bottom perspective view illustrating the underbody air and thermal management system of FIG. 1 in a third mode of operation wherein the louver system is in the open position and the air dam is in the deployed position to maximize airflow under hood through the engine bay during high engine load operation.

Reference will now be made in detail to the present preferred embodiments of the underbody air and thermal management system, examples of which are illustrated in the accompanying drawing figures.

### DETAILED DESCRIPTION

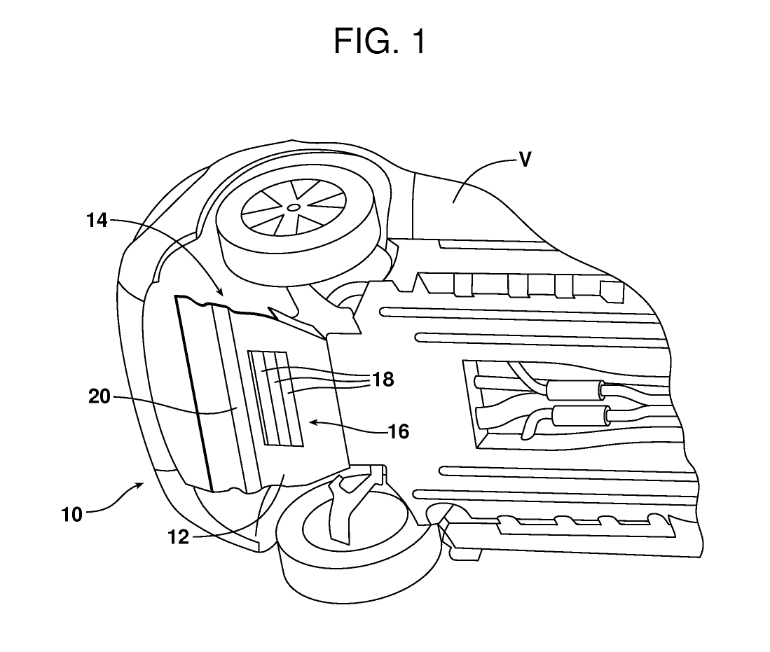

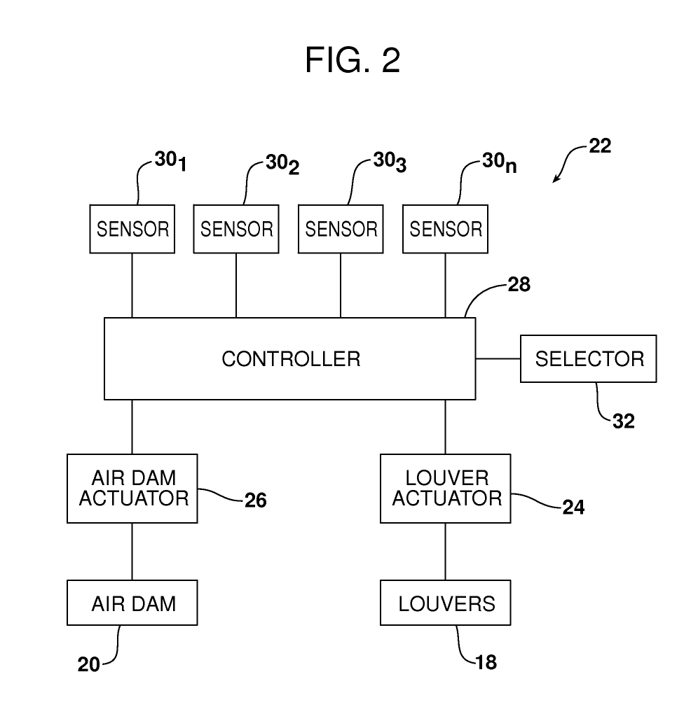

Reference is now made to FIGS. 1 and 2 illustrating the underbody air and thermal management system 10 that is the subject matter of this document. FIG. 1 illustrates a motor vehicle V incorporating the underbody air and thermal management system 10. That underbody air and thermal management system 10 includes an aero shield 12 underlying the hood (not shown) and an engine bay 14 of the motor vehicle V including the heat exchangers, internal combustion engine and other components of the operating systems of the motor vehicle.

As illustrated in FIG. 1, the aero shield 12 includes a louver system 16 incorporating a plurality of louvers 18 that may be selectively displaceable between an open position and a closed position as will be illustrated and described in greater detail below.

The underbody air and thermal management system 10 also includes an air dam 20 that is selectively displaceable between a home position and a deployed position as will be illustrated and described in greater detail below. Still further, as illustrated in FIG. 2, the underbody thermal management system 10 also includes a control system, generally designated by reference 22. That control system 22 is provided to selectively displace the louver system 16 between the open position and the closed position and the air dam 20 between the home position and the deployed position.

As illustrated in FIG. 2, the control system 22 includes a louver system actuator 24, an air dam actuator 26 and a controller 28 in the form of a dedicated microprocessor or electronic control unit (ECU) specifically configured to operate the louver system actuator and the air dam actuator. As known in the art, such a controller 28 may comprise one or more processors, one or more memories and one or more network interfaces. The processors, memories and interfaces all communicate with each other over a communication bus.

As further illustrated in FIG. 2, the control system 22 also includes at least one sensor 30₁, 30₂, 30₃, 30n connected to the controller 28. In the illustrated embodiment, four such sensors 30₁, 30₂, 30₃, 30ₙ are shown. Sensor 30₁ may be an engine coolant temperature sensor. Sensor 30₂ may be a transmission oil temperature sensor. Sensor 30₃ may be an engine charge air temperature sensor. Sensor 30ₙ may be an under hood air temperature sensor. The controller 28 may include any one, any two, any three or all four of the sensors 30₁, 30₂, 30₃, 30ₙ in any combination, alone or with any additional sensor providing data appropriate for the control of the underbody thermal management system 10.

As further illustrated in FIG. 2, the control system 22 may also include a vehicle operating mode selector 32. This selector 32 may be manipulated by the vehicle operator whenever the motor vehicle V is to be operated off road when maximum ground clearance is a priority. In alternative embodiments, the selector 32 may take the form of inputs from one or more sensors, devices, or operator-selected settings that individually or collectively determine whether the motor vehicle V is being operated off road.

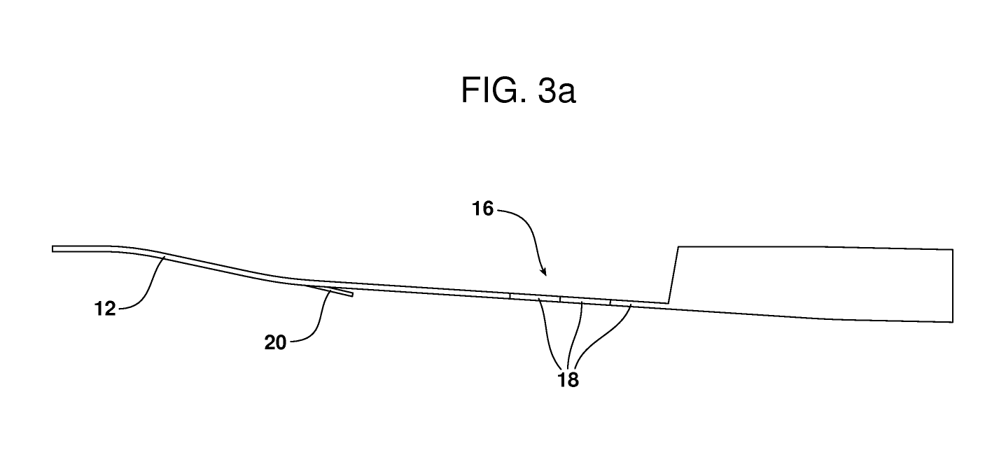

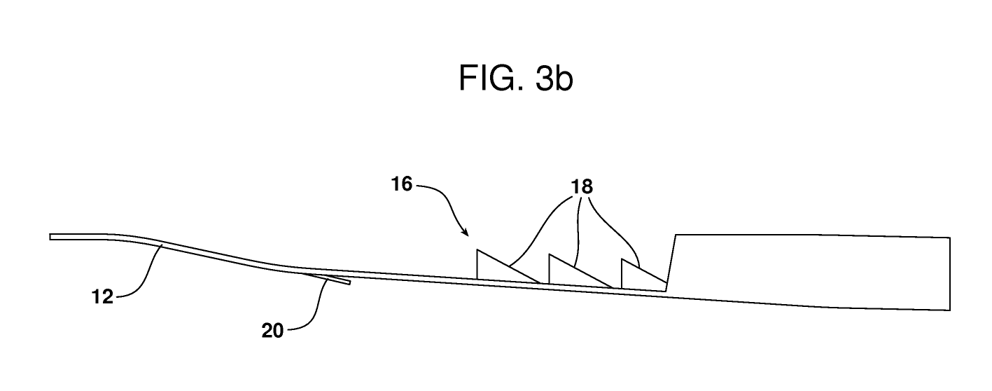

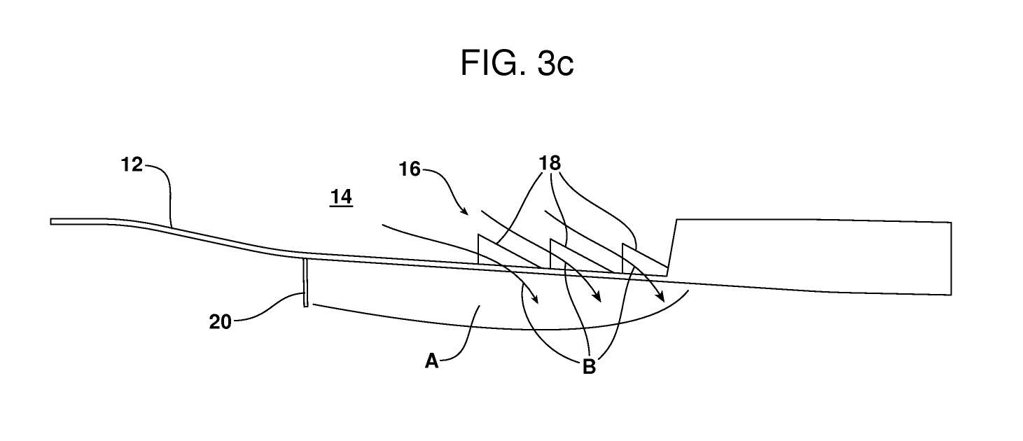

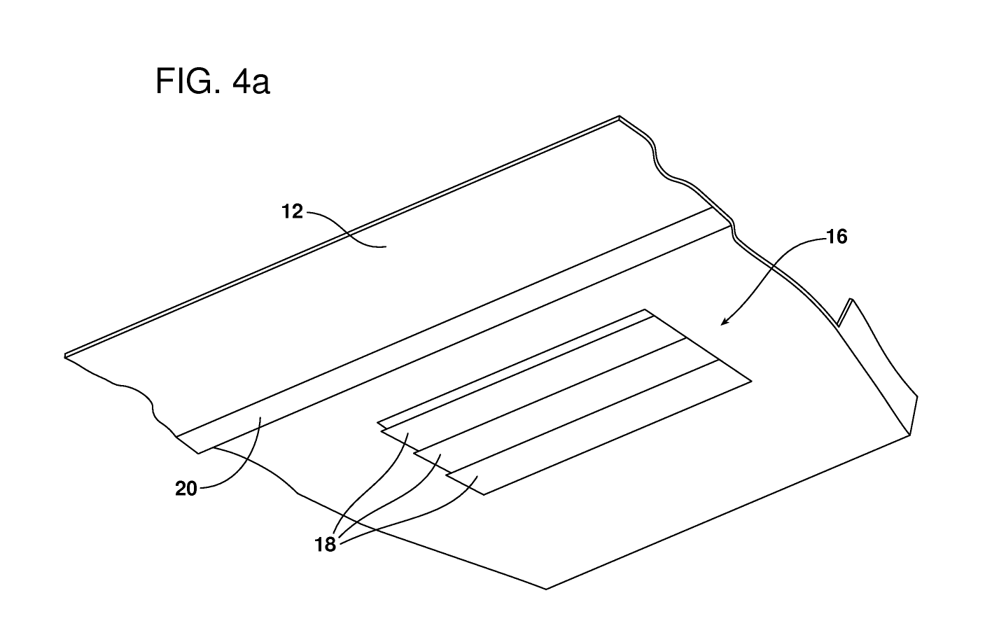

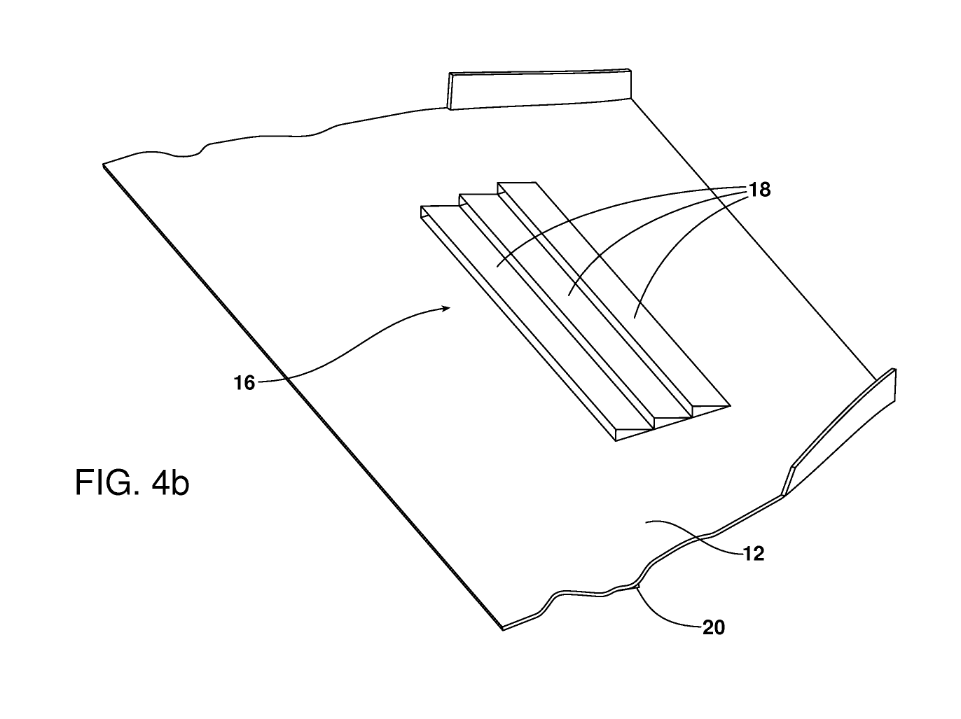

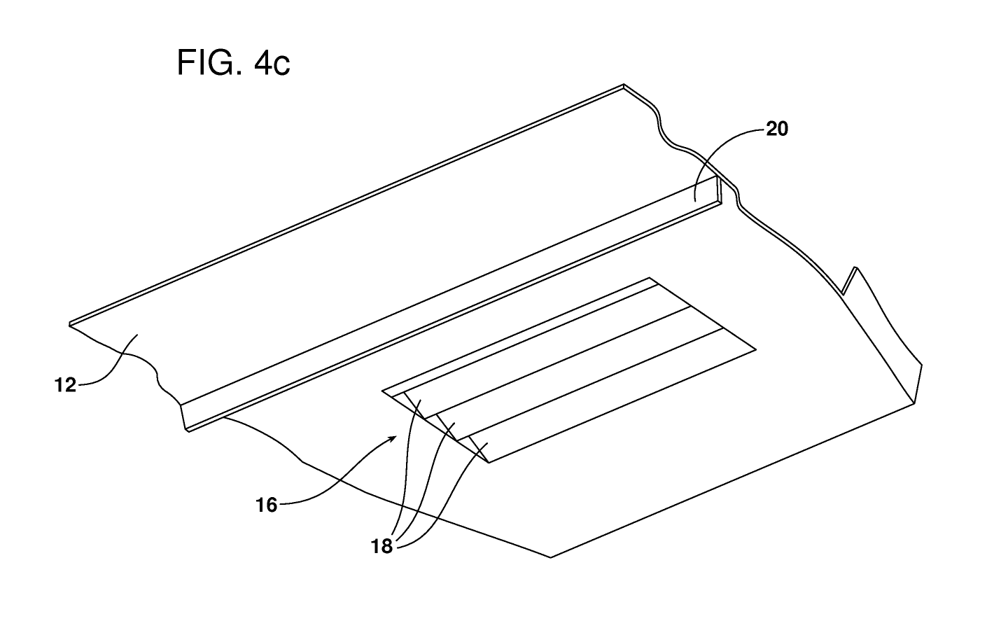

As best illustrated in FIGS. 3a-3c and 4a-4c, the controller 28 is configured to provide three modes of operation. In a first mode illustrated in FIGS. 3a and 4a, the louvers 18 of the louver system 16 are provided in the closed position and the air dam 20 is provided in the home position. This configuration of the louvers 18 and air dam 20 minimizes air drag for air passing underneath the motor vehicle V and thereby effectively functions to maximize fuel economy. The first mode of operation illustrated in FIGS. 3a and 4a is typically utilized during normal motor vehicle operation characterized by low engine power demand and low coolant/transmission oil/engine charge air temperature. In other words, whenever data provided by the sensors 30₁, 30₂, 30₃ and 30ₙ indicates low coolant temperature, low transmission oil temperature, low engine air charge temperature and/or low under hood air temperature, the controller 28 provides control signals to the louver system actuator 24 and air dam actuator 26 to maintain the louvers 18 in the closed position and the air dam 20 in the home position as per the first mode of operation.

In a second mode of operation, the controller 28 is configured to selectively displace the louvers 18 of the louver system 16 into the open position while maintaining the air dam 20 in the home position as illustrated in FIGS. 3b and 4b. The controller 28 provides the second mode of operation illustrated in FIGS. 3b and 4b when the vehicle operating mode selector 32 indicates off-road operation and the sensors 30₁, 30₂, 30₃ and 30ₙ have provided engine coolant temperature data, transmission oil temperature data, engine charge air temperature data and/or under hood air temperature sensor data exceeding one or more predetermined values that cause the controller to select the second mode of operation.

FIGS. 3c and 4c illustrate the third mode of operation wherein the louvers 18 are provided in the open position and the air dam 20 is provided in the deployed position. More specifically, the controller 28 is configured to provide this third mode of operation whenever the sensors 30₁, 30₂, 30₃ and 30ₙ provide data indicating that the engine coolant temperature, the transmission oil temperature, the engine charge air temperature and/or the under hood air temperature have exceeded one or more predetermined values that trigger the third mode of operation and the vehicle operating mode selector 32 indicates that the motor vehicle V is not being operated off road. Under these conditions, the third mode of operation is selected by the controller which sends a control signal to the louver system actuator 24 to open the louvers 18 and a control signal to the air dam actuator 26 to deploy the air dam 20. While the deployment of the air dam 20 does decrease ground clearance by up to 50 mm or more, the indication from the vehicle operating mode selector 32 that the motor vehicle V is not being operated off road makes this a desirable trade-off for improved under hood or engine bay cooling.

More specifically, the deployment of the air dam 20 creates a low-pressure area A immediately behind the air dam 20 and underlying the louvers 18. That low pressure area A serves to more efficiently and effectively draw air (note action arrows B in FIG. 3c only) from the engine bay 14 through the open louvers 18 so as to maximize under hood cooling of the engine bay 14. This serves to reduce the operating temperature in the engine by 14 to which engine components are subjected. This airflow sweeping through the engine bay 14 and out of the open louvers 18 enhances the operating efficiency of the various heat exchangers contained in the engine bay. As a result of the reduced operating temperatures, it is not necessary to provide larger and more expensive heat exchangers or engine components designed and capable of operating at higher operating temperatures. Thus, the underbody thermal management system 10 illustrated in this document incorporating both active louvers 18 and active air dam 20 provides a substantial benefit and represents a significant advance in the art.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. An underbody air and thermal management system for a motor vehicle, comprising:
an aero shield including a louver system selectively displaceable between an open position and a closed position;
an air dam selectively displaceable between a home position and a deployed position; and
a control system to displace said louver system between said open position and said closed position and said air dam between said home position and said deployed position.

2. The underbody air and thermal management system of claim 1, wherein said air dam is positioned vehicle forward of said louver system whereby when said air dam is in said deployed position said air dam forms a low pressure area along an underside of said louver system to enhance airflow from an engine bay area through said louver system when said louver system is in said open position thereby providing enhanced engine bay cooling.

3. The underbody air and thermal management system of claim 2, wherein said control system includes a louver system actuator, an air dam actuator and a controller configured to operate said louver system actuator and said dam actuator and thereby selectively displace (a) said louver system between said open position and said closed position and (b) said air dam between said home position and said deployed position.

4. The underbody air and thermal management system of claim 3, wherein said control system includes at least one sensor connected to said controller, said at least one sensor being selected from a group of sensors consisting of an engine coolant temperature sensor, a transmission oil temperature sensor, an engine charge air temperature sensor, an under hood air temperature sensor and combinations thereof.

5. The underbody air and thermal management system of claim 4, wherein said control system further includes a vehicle operating mode selector.

6. The underbody air and thermal management system of claim 5, wherein said controller is configured to provide three modes of operation wherein in a first mode said louver system is in the closed position and said air dam is in said home position to minimize air drag and maximize fuel economy.

7. The underbody air and thermal management system of claim 6, wherein in a second mode of operation, said louver system is in said open position and said air dam is in said home position to increase air flow through said engine bay while maximizing ground clearance for off road operation of the motor vehicle.

8. The underbody air and thermal management system of claim 7, wherein in a third mode of operation, said louver system is in said open position and said air dam is in the deployed position to maximize air flow through said engine bay during high engine load operation.

9. A motor vehicle equipped with the underbody air and thermal management system of claim 1.

10. A method of managing air flow through an engine bay of a motor vehicle, comprising:
equipping said motor vehicle with an underbody air and thermal management system including; (a) an aero shield having a louver system displaceable between an open position and a closed position, (b) an air dam displaceable between a home position and a deployed position, and (c) a control system to displace said louver system and said air dam.

11. The method of claim 10, further including providing said control system with a louver system actuator, an air dam actuator and a controller configured to operate said louver system actuator and said air dam actuator and thereby selectively displace (a) said louver system between said open position and said closed position and (b) said air dam between said home position and said deployed position.

12. The method of claim 11, further including sensing engine coolant temperature by means of an engine coolant temperature sensor and providing engine coolant temperature data to said controller.

13. The method of claim 11, further including sensing under hood air temperature by means of an under hood air temperature sensor and providing under hood air temperature data to said controller.

14. The method of claim 11, further including sensing transmission oil temperature by means of a transmission oil temperature sensor and providing transmission oil temperature data to said controller.

15. The method of claim 11, further including sensing engine charge air temperature by means of an engine charge air temperature sensor and providing engine charge air temperature data to said controller.

16. The method of claim 11, further including sensing any combination of engine coolant temperature, under hood air temperature, transmission oil temperature and engine charge air temperature by means of sensors and providing data relating to said any combination of engine coolant temperature, under hood air temperature, transmission temperature and engine charge air temperature to said controller.

17. The method of claim 11, further including configuring said controller to provide a first mode of operation wherein said louver system is in the closed position and said air dam is in said home position to minimize air drag and maximize fuel economy.

18. The method of claim 17, further including configuring said controller to provide a second mode of operation wherein said louver system is in said open position and said air dam is in said home position to increase air flow through said engine bay while maximizing ground clearance for off road operation of the motor vehicle.

19. The method of claim 18, further including configuring said controller to provide a third mode of operation wherein said louver system is in said open position and said air dam is in the deployed position to maximize air flow through said engine bay during high engine load operation.

20. The method of claim 11, further including configuring said controller to provide one mode of operation wherein said louver system is in the closed position and said air dam is in said home position to minimize air drag and maximize fuel economy and another mode of operation wherein said louver system is in said open position and said air dam is in the deployed position to maximize air flow through said engine bay during high engine load operation.
